(19) United States
(12) Patent Application Publication
(10) Pub. No.: US 2010/0301758 A1
(43) Pub. Date: Dec. 2, 2010

(54) FLAT DISPLAY DEVICE BLACKLIGHT MODULE THEREOF FOR NIGHT VISION IMAGING SYSTEM

(75) Inventor: Chun-Hung Chen, Hsinchu (TW)

Correspondence Address: QUINTERO LAW OFFICE, PC, 615 Hampton Dr, Suite A202, Venice, CA, 90291, US

(73) Assignee: MITAC TECHNOLOGY CORP., Hsinchu (TW)

(21) Appl. No.: 12/477,036

(22) Filed: Jun. 2, 2009

(51) Int. Cl. H05B 37/02

(52) U.S. Cl. 315/154; 315/297

(57) ABSTRACT

A flat display device is adapted for human eye observation with or without applying a NVIS (Night Vision Imaging System). The flat display device includes a display panel, a backlight module and a backlight driving unit. The backlight module includes multiple red light LEDs (Light Emitting Diodes), green light LEDs and blue light LEDs that form together a light source array, so as to generate a backlight by mixing and projecting the red light, green light and blue light to the display panel. The backlight driving unit is electrically connected with the light source array and used to drive and control the red light LEDs, green light LEDs and blue light LEDs. At a night-vision mode, the backlight driving unit may, upon actuation of a actuating signal, adjust or disable the red light LED by for example decreasing or turning off the driving electricity sent to the red light LED, thereby achieving the requirements for nigh vision purposes.

### BACKGROUND OF THE INVENTION

1. Field of the Invention

The present invention relates to the design of a flat display device, and more particularly to a flat display device and backlight module thereof adapted for a night vision imaging system (NVIS).

2. Related Art

NVIS (Night Vision Imaging System) may be used for very broad purposes, such as security monitoring, night activity, environment observation; the major application is for military purposes. The principle of NVIS is to use optical components to observe target objects at night. The current major types of the NVIS optical components include image intensifier tubes and IR (Infrared) night vision system. The image intensifier tube enhances the weak light at night, especially providing a substantial light intensity gain in the spectrum of the transmitted red light to illustrate on a display device.

Currently, a military-purpose flat display device mainly adjusts its brightness to a very low level for the usage of the NVIS. However, the flat display device is usually not made dedicated to the NVIS. After adjusting the brightness, the flat display device still can not meet the requirements for the enhanced light gaining function of the NVIS, and causes the discomfort of the user when using the NVIS watching the display device. Thus, an optic filter with a transmitted light range 400 nm to 600 nm will be attached to the external surface of the flat display device so as to isolate most of the red light and meeting the requirements of image specifications for the NVIS.

However the optic filter is expensive and becomes a major burden of a NVIS user. Furthermore, for a flat display device equipped with a “touch control” function, the touch control function of the flat display device will be seriously affected or malfunctioned after attaching the optic filter. Meanwhile, in an environment with sufficient light, the optic filter attached outside the flat display device becomes a problem since in such condition the user needs to remove the NVIS to see a normal image on the flat display device without the optic filter. Therefore, considering both the two usages of NVIS and normal modes will inevitably increasing the difficulties of mechanical designs. Besides, the user has to store and carry the optic filter very properly, which brings unnecessary inconveniences to the user.

### SUMMARY OF THE INVENTION

To solve the aforesaid problems of the prior art, the present invention provides a flat display device and backlight module thereof adapted for a NVIS (night vision imaging system). The flat display device and its backlight module are operable under different environmental light conditions without applying any optic filter but meet the requirements of the NVIS under both a normal mode and a night-vision mode.

In an embodiment of the present invention, a flat display device is adapted for human eye observation with or without a night vision imaging system (NVIS). The flat display device comprises a display panel, a backlight module, and a backlight driving unit. The display panel comprises a plurality of liquid crystal pixel arrays that is controlled by a liquid crystal control signal generated from an image processing device. The backlight module comprises a light source array with multiple red light LEDs (Light Emitting Diodes), green light LEDs and blue light LEDs. The light source array generates a red light, a green light and a blue light and projects to the display panel. The backlight driving unit is electrically connected with the light source array. The backlight driving unit drives and controls the red light LEDs, green light LEDs and blue light LEDs of the backlight module; wherein at a night-vision mode the backlight driving unit, upon actuation of a actuating signal, adjusts or turns off a driving electricity sent to the red light LED, thereby adjusting or turning off the generated red light for human eye observation with the NVIS.

In a preferred embodiment of the present invention, the backlight driving unit may adjust the driving electricity sent to the red light LED by an actuating signal from a night-vision actuating unit or a sensing unit. Meanwhile, the backlight driving unit may adjust the driving electricity sent to the red light LED according to a preset ratio.

In another embodiment of the present invention, a backlight module is adapted for human eye observation with or without a night vision imaging system (NVIS). The backlight module provides a red light, a green light and a blue light and projects to a display panel. The backlight module comprises multiple red light LEDs, green light LEDs and blue light LEDs, and a backlight driving unit. The multiple red light LEDs, green light LEDs and blue light LEDs forms together as a light source array. The light source array generates the red light, green light and blue light and projects to the display panel. The backlight driving unit is electrically connected with the light source array. The backlight driving unit drives and controls the red light LEDs, green light LEDs and blue light LEDs; wherein at a night-vision mode the backlight driving unit, upon actuation of a actuating signal, adjusts or turns off a driving electricity sent to the red light LED, thereby adjusting or turning off the generated red light for human eye observation with the NVIS.

Since the present invention does not require an optic filter, certain cost may be saved and the display performance or the tough control function of the flat display device will not be affected by the optic filter. Even when the flat display device is used for military purposes, since the optic filter is not require, the flat display device can maintain the same level of color performance as a general commercial-model flat display device. Even better, using the RGB three-color LED for the flat display device of the present invention may have better color performance.

Moreover, the switch operation between the normal mode and the night-vision mode is very easy. The user may, whenever necessary, manually operate the night-vision actuating unit to switch between the normal mode and the night-vision mode. Alternatively, a sensing unit may be used to make the backlight driving unit automatically adjust the generated red light according to a preset ratio and based on the light changes of the external environment, so that the user will be able to see the most optimized/appropriate images displayed under various light conditions.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is a system diagram illustrating a flat display device operating at a normal mode according to an embodiment of the present invention;

FIG. 2 is a perspective view of a light source array with red, green, blue light LEDs (light emitting diode) aligned on different light bars;

FIG. 3 is another perspective view of a light source array with same RGB LEDs aligned on every light bar, wherein each RGB LED is incorporated with three colors of LEDs including a red light LED, a green light LED and a blue light LED;

FIG. 4 is a system diagram illustrating a flat display device operating at a night-vision mode according to another embodiment of the present invention;

FIG. 5 is a spectrum diagram of the transmitted backlight at the normal mode according to another embodiment of the present invention;

FIG. 6 is a spectrum diagram of the transmitted backlight at the night-vision mode according to another embodiment of the present invention, wherein the red light LED is disabled;

FIG. 7 is a spectrum diagram of the transmitted backlight at the night-vision mode according to another embodiment of the present invention; wherein the red light LED has decreased brightness; and

FIG. 8 is a system diagram illustrating another flat display device operating at a normal mode according to another embodiment of the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

In the present invention, the flat display device and its backlight module are operable under different environmental light conditions without applying any optic filter but meet the requirements of the NVIS under both a normal mode and a night-vision mode. The normal mode for the flat display device and its backlight module is defined as displaying images on the flat display device with white backlight so that the displayed images are visible for human eyes. The night-vision mode for the flat display device and its backlight module is defined as displaying images on the flat display device with adjusted backlight (low red light or non-red light) so that the displayed images are visible for human eyes observing through a NVIS.

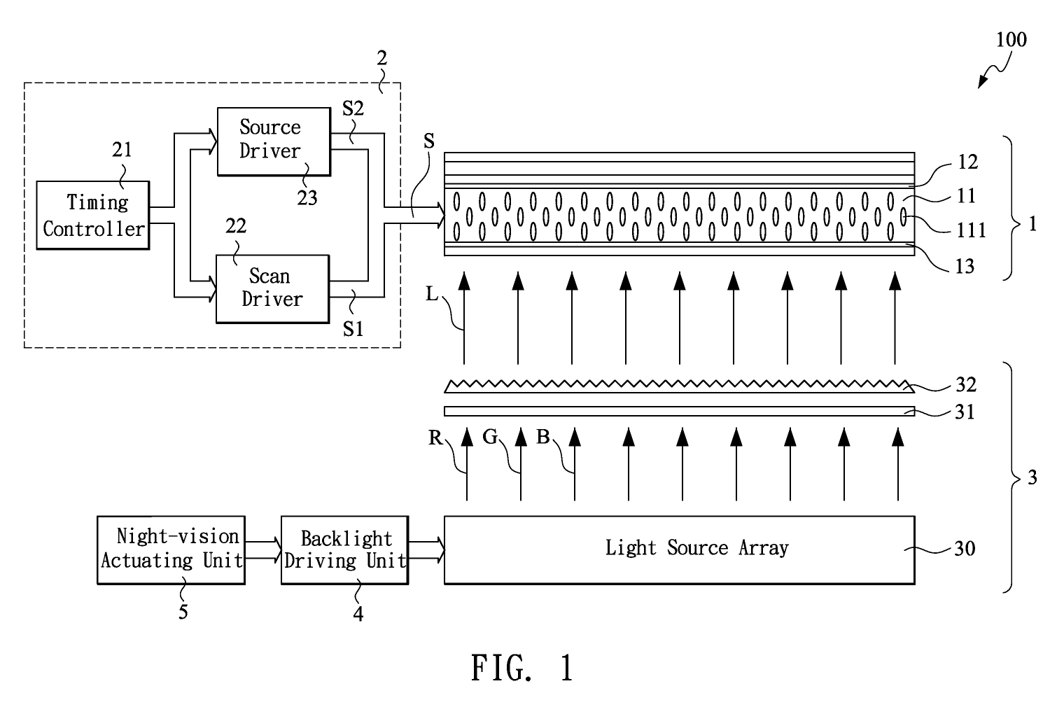

Please refer FIG. 1, which is a system diagram illustrating a flat display device operating at a normal mode according to an embodiment of the present invention. As shown in the drawing, a flat display device 100 includes a display panel 1, an image processing device 2, a backlight module 3, a backlight driving unit 4 and a night-vision actuating unit 5.

The display panel 1 in the present embodiment is a liquid crystal panel, which mainly includes a liquid crystal layer 11 and two electrode layers 12, 13 configured above and beneath the liquid crystal layer 11. The liquid crystal layer 11 includes multiple liquid crystal pixel arrays 111. The liquid crystal pixel arrays 111 are very sensitive to external electric field, so when few electric charges are added to the electrode layers 12, 13, the liquid crystal pixel arrays 111 will rotate correspondingly to allow the light to pass or be blocked.

The image processing device 2 uses a liquid crystal control signal S to control the liquid crystal pixel arrays 111 of the display panel 1. The image processing device 2 mainly includes a timing controller 21, a scan driver and a source driver 23.

The scan driver 22 uses a liquid crystal adjusting signal S1 to adjust the rotation of the liquid crystal pixels within the liquid crystal pixel arrays 111, so as to determine the open/close operation that allows the light to pass or not. The source driver 23 inputs a pixel signal S2 to the display panel 1. When the image processing device 2 receives image inputs (not shown), the scan driver 22 will adjust the open/closer operations of the liquid crystal pixel arrays 111 according to the clocking control of the timing controller 21, meanwhile the source driver 23 inputs the pixel signal S2 correspondingly and makes the display panel 1 display images.

The backlight module 3 includes a light source array 30, which generates backlight L by mixing red light R, green light G and blue light B into white light. The while backlight L is projected towards the display panel 1 through a diffuser sheet 31 and a prism sheet 32.

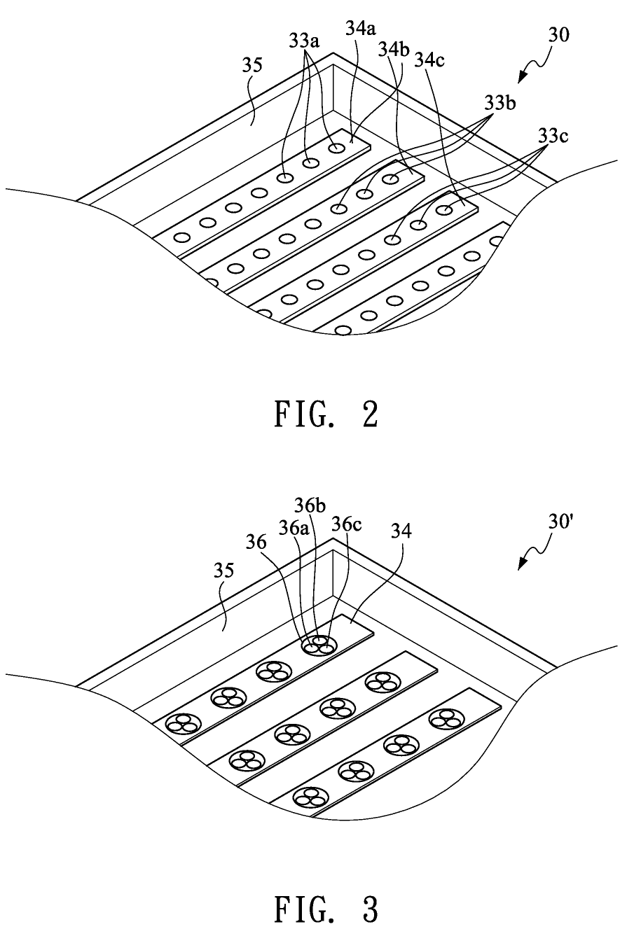

Please refer to FIG. 2, which is a perspective view of a light source array with red, green, blue light LEDs (light emitting diode) aligned on different light bars. The light source array 30 of the backlight module 3 includes multiple light bars 34a, 34b, 34c configured on a substrate 35. Every light bar 34a/b/c has multiple single-color LEDs configured thereon. The light bar 34a includes multiple red light LEDs 33a generating the red light R; the light bar 34b includes multiple green light LEDs 33b generating the green light G; and the light bar 34c include multiple blue light LEDs 33c generating the blue light B.

Please refer to FIG. 3, which is another perspective view of a light source array 30 with same RGB LEDs 36 aligned on every light bar 34; wherein each RGB LED is incorporated with three colors of LEDs including a red light LED 36a, a green light LED 36b and a blue light LED 36c. Aside from the white backlight source provided by the separately-configured red light LED 33a, green light LED 33b and blue light LED 33c in FIG. 2, now in FIG. 3 each of the RGB LEDs 36 also generates white backlight by packing the red light LED 36a, green light LED 36b and blue light LED 36c into a incorporated package for RGB LED 36.

The backlight driving unit 4 is electrically connected with the light source array 30 of the backlight module 3, so as to actuate/enable the red light LED 33a/36a, green light LED 33b/36b and blue light LED 33c/36c and make the red light LED 33a/36a, green light LED 33b/36b and blue light LED 33c/36c generate the red light R, green light G and blue light B respectively.

The night-vision actuating unit 5 is electrically connected with the backlight driving unit 4. The night-vision actuating unit 5 may be a simple electrical switch element. In actual applications, the night-vision actuating unit 5 may be connected through wire connections or wireless connections to electrically connect with the backlight driving unit 4, so as to allow the user to manually operate the night-vision actuating unit 5 and then control the backlight driving unit 4 to switch the flat display device 100 to the night-vision mode.

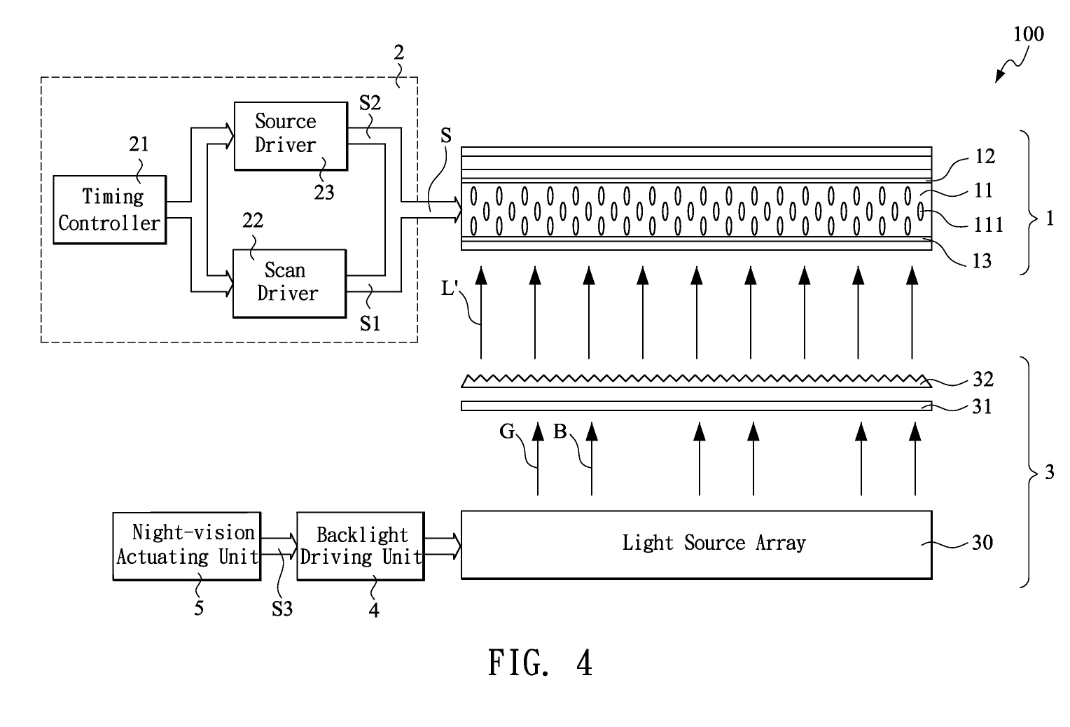

Please refer to FIG. 4, which is a system diagram illustrating a flat display device operating at a night-vision mode according to another embodiment of the present invention. When the user operates the night-vision actuating unit 5, the night-vision actuating unit 5 will generate an actuating signal S3 and send to the backlight driving unit 4. The backlight driving unit 4, upon actuation of the actuating signal S3, decreases or turns off the driving electricity sent to the red light LED 33a, or simply disables the red light LED 33a, so that the backlight module 3 and the flat display device 100 will enter the night-vision mode correspondingly and display only low-intensity red light or non-red light (green/blue light only).

In the present embodiment, the backlight driving unit 4 may completely turn off the driving electricity sent to the red light LED 33a, thereby achieving the low red light requirements of night vision purpose. Certainly, since LED has the characteristic of linear luminance, the backlight driving unit 4 may, instead of completely turning off (or disable) the red light R, decrease the driving electricity sent to the red light LED 33a according to a preset ratio, thereby decreasing the red light R displayed on the display panel 1 according to a desired ratio.

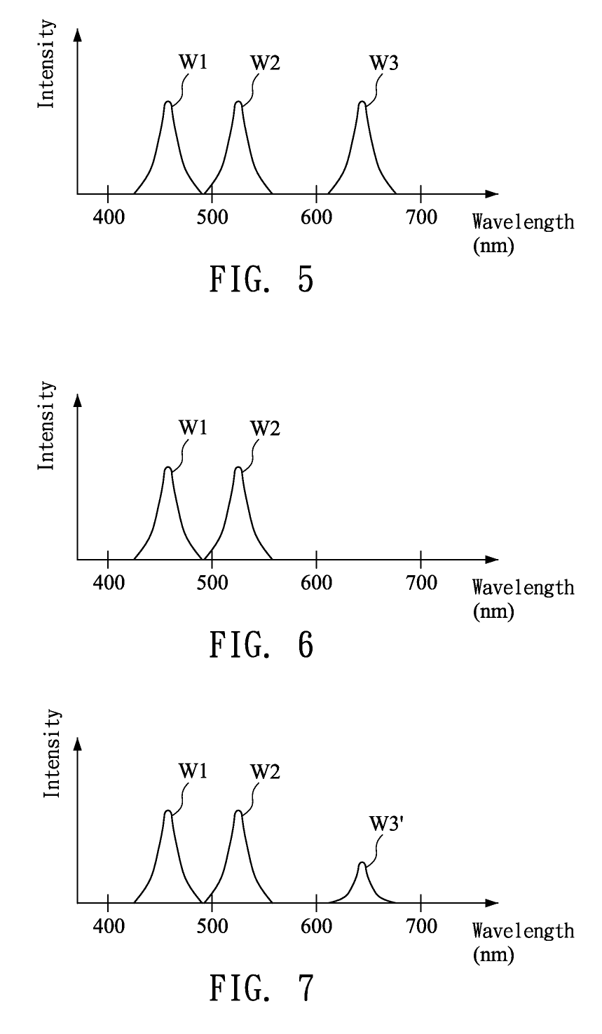

Please refer to FIG. 5, FIG. 6 and FIG. 7. FIG. 5 is a spectrum diagram of the transmitted backlight at the normal mode according to another embodiment of the present invention. FIG. 6 is a spectrum diagram of the transmitted backlight at the night-vision mode according to another embodiment of the present invention, wherein the red light LED is disabled. FIG. 7 is a spectrum diagram of the transmitted backlight at the night-vision mode according to another embodiment of the present invention; wherein the red light LED has decreased brightness. In the three drawings, the lengthwise axis is light intensity and the horizontal axis represents the wavelength.

At the normal mode, in FIG. 5, the spectrum diagram of the backlight L provided to the display panel 1 shows a curve W1 (average wavelength about 470 nm) representing the blue light, a curve W2 (average wavelength about 530 nm) representing the green light and a curve W3 (average wavelength about 630 nm) representing the red light. These lights of three colors red, green and blue are mixed into white light and provide normal, regular display performance as a general display panel 1.

At the night-vision mode, the red light LED 33a/36a is completely turned off or disabled in FIG. 6, so the backlight L′ provided to the display panel 1 may show on its spectrum diagram only the curve W1 representing the blue light B and the curve W2 representing the green light G; such spectrum meets the requirements of night vision purposes through the NVIS. On the other had, the night-vision actuating unit 5 may send the actuating signal S3 to the backlight driving unit 4 to decrease the generated red light according to the preset ratio. For example, through decreasing the driving electricity sent to the red light LED 33a/36a, the generated red light may be decreased to 50%, 10% or even 1% of the full-generated red light at the normal mode, so the light intensity of the generated red light (curve W3′) in the spectrum diagram of FIG. 7 will show the decreasing intensity of the red light.

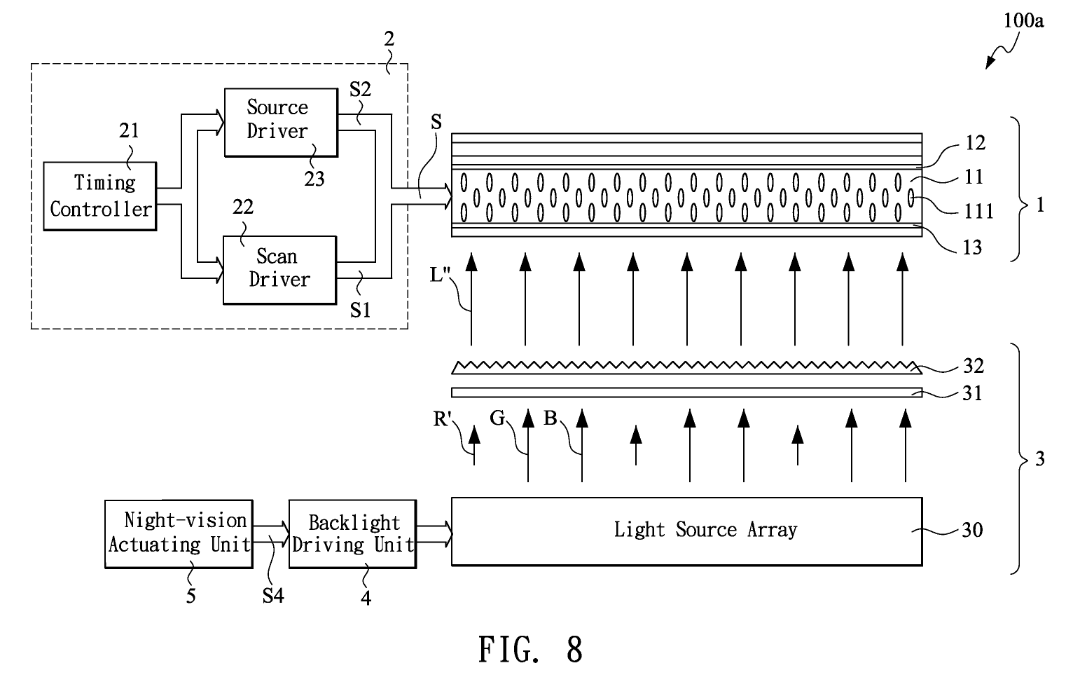

FIG. 8 is a system diagram illustrating another flat display device operating at a normal mode according to another embodiment of the present invention. In the present embodiment the flat display device 100a has similar structures and compositions as the embodiments mentioned above, and the same elements are marked with the same numerals for easy corresponding. The major difference is that in FIG. 8, the backlight driving unit 4 is electrically connected with a sensing unit 6.

The sensing unit 6 in the present embodiment is a light sensor that senses the light changes of the external environment and accordingly sends an actuating signal S4 to the backlight driving unit 4. Based on the actuating signal S4 sent from the sensing unit 6, the backlight driving unit 4 will adjust the driving electricity sent to the red light LED 33a/36a according to a preset ratio, so that the generated red light R′ provided to the display panel 1 is adjusted accordingly and the backlight L″ provide to the display panel 1 is adjusted as well. Through the sensing unit 6, the flat display device 100a may have the red light R′ automatically adjusted according to the light changes of the external environment, so as to display the most appropriate images for the user under various light conditions.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A flat display device adapted for human eye observation with or without a night vision imaging system (NVIS), comprising:
a display panel, comprising a plurality of liquid crystal pixel arrays that is controlled by a liquid crystal control signal generated by an image processing device;
a backlight module, comprising a light source array with a plurality of red light LEDs (Light Emitting Diodes), green light LEDs and blue light LEDs, the light source array generating a red light, a green light and a blue light and projecting to the display panel; and
a backlight driving unit electrically connected with the light source array, driving and controlling the red light LEDs, green light LEDs and blue light LEDs of the backlight module, wherein at a night-vision mode the backlight driving unit, upon actuation of a actuating signal, adjusts or turns off a driving electricity sent to the red light LED, thereby adjusting or turning off the generated red light for human eye observation with the NVIS.

2. The flat display device as claimed in claim 1, wherein the red light LED, green light LED and blue light LED of the backlight module are packed into a incorporated package as a RGB (Red Green Blue) LED.

3. The flat display device as claimed in claim 1, wherein the backlight driving unit is further electrically connected with a night-vision actuating unit, the night-vision actuating unit generating the actuating signal to control the backlight driving unit to adjust of turn off the driving electricity sent to the red light LED.

4. The flat display device as claimed in claim 3, wherein the night-vision actuating unit comprises an electrical switch element.

5. The flat display device as claimed in claim 1, wherein the backlight driving unit is further connected with a sensing unit, the sensing unit generating the actuating signal to control the backlight driving unit to adjust or turn off the driving electricity sent to the red light LED.

6. The flat display device as claimed in claim 5, wherein the sensing unit comprises a light sensor.

7. The flat display device as claimed in claim 1, wherein the backlight driving unit adjusts the driving electricity sent to the red light LED through a preset ratio.

8. A backlight module adapted for human eye observation with or without a night vision imaging system (NVIS), providing a red light, a green light and a blue light and projecting to a display panel, the backlight module comprising:
a plurality of red light LEDs (Light Emitting Diodes), green light LEDs and blue light LEDs that form together as a light source array, the light source array generating the red light, green light and blue light and projecting to the display panel; and
a backlight driving unit electrically connected with the light source array, driving and controlling the red light LEDs, green light LEDs and blue light LEDs, wherein at a night-vision mode the backlight driving unit, upon actuation of a actuating signal, adjusts or turns off a driving electricity sent to the red light LED, thereby adjusting or turning off the generated red light for human eye observation with the NVIS.

9. The backlight module as claimed in claim 8, wherein the red light LED, green light LED and blue light LED of the backlight module are packed into a incorporated package as a RGB (Red Green Blue) LED.

10. The backlight module as claimed in claim 8, wherein the backlight driving unit is further electrically connected with a night-vision actuating unit, the night-vision actuating unit generating the actuating signal to control the backlight driving unit to adjust of turn off the driving electricity sent to the red light LED.

11. The backlight module as claimed in claim 10, wherein the night-vision actuating unit comprises an electrical switch element.

12. The backlight module as claimed in claim 8, wherein the backlight driving unit is further connected with a sensing unit, the sensing unit generating the actuating signal to control the backlight driving unit to adjust or turn off the driving electricity sent to the red light LED.

13. The backlight module as claimed in claim 12, wherein the sensing unit comprises a light sensor.

14. The backlight module as claimed in claim 8, wherein the backlight driving unit adjusts the driving electricity sent to the red light LED through a preset ratio.

15. A flat display device adapted for human eye observation with or without a night vision imaging system (NVIS), comprising:
a display panel, comprising a plurality of liquid crystal pixel arrays that is controlled by a liquid crystal control signal generated by an image processing device;
a backlight module, comprising a light source array with a plurality of red light LEDs (Light Emitting Diodes), green light LEDs and blue light LEDs, the light source array generating a red light, a green light and a blue light and projecting to the display panel; and
a backlight driving unit electrically connected with the light source array, driving and controlling the red light LEDs, green light LEDs and blue light LEDs of the backlight module, wherein at a night-vision mode the backlight driving unit adjusts or turns off a driving electricity sent to the red light LED, thereby adjusting or turning off the generated red light for human eye observation with the NVIS.

16. The flat display device as claimed in claim 15, wherein the red light LED, green light LED and blue light LED of the backlight module are packed into a incorporated package as a RGB (Red Green Blue) LED.

17. The flat display device as claimed in claim 15, wherein the backlight driving unit is further electrically connected with a night-vision actuating unit, the night-vision actuating unit generating a actuating signal to actuate and control the backlight driving unit to adjust of turn off the driving electricity sent to the red light LED.

18. The flat display device as claimed in claim 17, wherein the night-vision actuating unit comprises an electrical switch element.

19. The flat display device as claimed in claim 15, wherein the backlight driving unit is further connected with a sensing unit, the sensing unit generating the actuating signal to control the backlight driving unit to adjust or turn off the driving electricity sent to the red light LED.

20. The flat display device as claimed in claim 19, wherein the sensing unit comprises a light sensor.
